(19) United States
(12) Patent Application Publication
(10) Pub. No.: US 2005/0097135 A1
(43) Pub. Date: May 5, 2005

(54) Touch panel user interface

(76) Inventors: Ian Epperson, Sunnyvale, CA (US); Lawrence Kesteloot, San Francisco, CA (US); Stephen Watson, Toronto (CA)

Correspondence Address: SWERNOFSKY LAW GROUP PC, P.O. BOX 390013, MOUNTAIN VIEW, CA, 94039-0013, US

(21) Appl. No.: 10/936,789

(22) Filed: Sep. 8, 2004

Related U.S. Application Data
(63) Continuation-in-part of application No. 10/418,949, filed on Apr. 18, 2003.
(63) Continuation-in-part of application No. 10/418,739, filed on Apr. 18, 2003.
(63) Continuation-in-part of application No. 10/655,496, filed on Sep. 3, 2003.

(51) Int. Cl. G06F 17/00

(52) U.S. Cl. 707/104.1

(57) ABSTRACT

A user interface, both providing relatively high quality graphic output and receiving input signals from a pointing device with substantially direct physical contact, or other movement by a user, such as typing in a projected ₃D field looking like a keyboard. A touch panel allows the user to sort and filter titles by their metadata, and to visually picture the relative closeness of multiple titles. The touch panel includes a presentation of individually selected titles by their cover art, along with associated metadata for those titles. The user can view textual metadata for titles concurrently with viewing cover art for those titles. A progress bar presents a location within a title, such as a media stream or a database, currently being, or having been, presented to the user.

This application is submitted in the name of the following inventors:

| Inventor | Citizenship | Residence City and State |
|---|---|---|
| Ian EPPERSON | United States | Sunnyvale, California |
| Lawrence KESTELOOT | United States | San Francisco, California |
| Stephen WATSON | Canada | Toronto, Ontario (Canada) |

### BACKGROUND OF THE INVENTION

1. Field of the Invention

The invention relates to a touch panel user interface; for example, not intended to be limiting in any way, in one embodiment, the user interface might be used to control presentation of media streams in a home entertainment system.

2. Related Art

In presentation systems for media streams and other information (such as for example, home entertainment systems), it is advantageous to provide users with a user interface that is simultaneously natural, easy to use, and powerful in its ability to command the system. In the case of a home entertainment system, or any other system involving substantial attention to be paid by the user to the system and not to the controls, it would be particularly advantageous if the controls themselves were to be similar to the display provided by the home entertainment system.

Known user interfaces on touch panels are similar to user interfaces on computers: when a set of objects is presented, the user must first press on the object of interest, which has the effect of highlighting the object, then press another object (such as a button) to perform some action on the highlighted object (such as showing more information about that object). There are at least two disadvantages to this paradigm on a touch interface: the interface requires a separate mechanism to navigate through the set of objects; and when the user wants to show interest in an object, he or she must press a different object (the button).

This invention provides a solution to both problems by eliminating both the navigation objects (such as arrow buttons) and the object required to perform an action. In one aspect, the invention provides a system that works as described below. Although a preferred embodiment is described below, alternate embodiments need include only one of these two solutions. For a first example, pressing on a peripheral object centers and highlights it, but the user must press a separate object (such as a button) to perform an action on the highlighted object. For a second example, the user has buttons to highlight various objects and navigate through the set of objects, but pressing on the highlighted object performs the default action.

The direct and natural selection of objects can be extended to manipulation. For example, the columns of a table can be reordered by dragging them. For a different example, a list of favorite movies can be created by dragging covers from a mosaic of covers into a box representing the user's favorite movies. For a different example, a scrollable list of movies can be shifted up or down by dragging up or down across the touch panel, simulating the motion of a real piece of paper. For another example, a picture taken by a digital camera can be rotated go degrees (if it was taken in portrait mode but saved in landscape mode) by putting two index fingers on opposite corners of the picture and rotating it in the proper direction.

Accordingly, it would be advantageous to provide a user interface not subject to drawbacks of the known art.

### SUMMARY OF THE INVENTION

The invention provides techniques, embodied in methods and systems, regarding user interfaces that are simultaneously natural, easy to use, and powerful in their ability to command the system.

In a first aspect, the invention is embodied in a system that includes a touch panel, capable of both providing relatively high quality graphic output and of receiving input signals from a pointing device with substantially direct physical contact with the touch panel display, such as a finger or stylus, with the effect that the user has the natural feeling of identifying or controlling screen elements that are presented. In the context of the invention, there is no particular requirement of involving actual touching. For an example, not intended to be limiting in any way, the system might be responsive to movement by a user (such as typing in a projected ₃D field looking like a keyboard), such as available with some PDA devices.

In one embodiment, the touch panel might present its information in a “frame” mode, in which the main home entertainment screen is duplicated within a frame on the touch panel, with additional information (either for control or for elucidation) being presented at positions other than within the frame.

For an example, not intended to be limiting in any way, the touch panel might show a frame including within it a presentation of a substantial duplicate of the graphic output being made on the home entertainment screen. However, because the presentation is limited to a frame smaller than the full screen size of the touch panel, the touch panel might also present a set of control elements (including channel and volume control), as well as other and further control elements. These other and further control elements might include (a) a list of bookmarks or watchpoints available in the ongoing presentation, (b) a progress bar, enhanced as described below, showing the amount of the media stream that has been presented so far, (c) other and further metadata, such as for example a set of alternative titles or alternative presentations that are concurrently available (for channel surfers), might also be made available outside the presentation frame on the touch panel.

Examples of such other and further metadata might include (a) descriptions or identifications of individual sub-streams within the media stream. For example, not intended to be limiting in any way, sub-streams (and sub-sub-streams, and the like), might be presented in one or more of the following ways.

In the event that the media stream includes a sequence of “scenes” (possibly including a moving picture or a still picture of a ₃D collection of objects), the metadata might include various information, such as for example: when that scene begins, when it ends, and what “sub-scenes” (for scenes for which this can be defined) are included within the scene. Such scenes in a moving picture might be detected by similar analysis as described above. Such scenes in a moving picture might be presented in the “progress bar” as separate (or separable) elements, such as for example: showing scenes at right angles to the regular progress bar, showing scenes at another angle to the regular progress bar, or linking scenes together using some form of arrow or indicator of continuation. The user might use that metadata to select a particular scene for presentation, to set (either deliberately or automatically) a bookmark or watchpoint within that particular scene, or to expand upon the scene to show its sub-scenes. In one embodiment, in the event that sub-scenes can be defined at a sufficiently short time resolution, the sub-scene might be presented as a direct sequence of still pictures. In alternative embodiments, thinking the scene itself might be presented at the speed with which the user moves his or her finger along the touch panel. In alternative embodiments, if the user moves his or her finger along a sequence of scenes, the system might present short clips from each of those scenes, thus presenting a “flavor” of the media stream without having to see the whole thing, and the like.

Examples of such other and further metadata might include (a) alternative or enhanced versions of scenes in the media stream, (b) alternative or enhanced versions of characters in the media stream, or (c) other modifications to the media stream capable of being computed in response to the media stream and in response to user input. For example, such other and further metadata might be used to present the media stream in one or more of the following ways.
In the event that the media stream includes alternative versions of a “scene” (possibly including a moving picture or a still picture of a ₃D collection of objects), the metadata might include various information such as direction from which to view that scene, degree of transparency, and the like. Such scenes in a moving picture might be detected by human analysis, color or light detection, AI determination of substantially similar scenes, and the like. Once detectable, the user might use that metadata to select among multiple possibilities for presentation, such as for example viewing a battlefield scene from a different height, and the like.

In the event that the media stream includes alternative versions of a “character” (possibly including an animated character, a wire frame description of a ₃D model, or a set of moving pictures or still pictures of a human actor), the metadata might include various information such as what locations that character fits into the media stream, what actions or emotions that character is displaying, and the like. Such scenes in a might be detected in similar manner as metadata for scenes, as described above. Once detectable, the user might use that metadata to select among multiple characters for presentation, such as for example substituting the character of Marilyn Monroe for Nicole Kidman in the movie “Moulin Rouge”, substituting actual newsreel footage of Josef Stalin for a foreign leader in a fictional work, substituting photographs of a selected fashion model for Evita Peron in newsreel footage, and the like.
In the event that the media stream includes alternative versions of a product (similar to alternative versions of a character), the metadata might include various similar information. Once detectable, the user might use that metadata to select among multiple products for presentation, such as for example showing how a particular article of clothing would look if worn by that user, and the like.

Particular value for the progress bar is that it can be integrated with a set of bookmarks or watchpoints (already supplied with the media stream, supplied from an alternative source as the media stream, or generated dynamically such as in response to other bookmarks or watchpoints or metadata as described above). For an example, not intended to be limiting in any way, very many (probably millions) of new bookmarks might be generated in response to linear interpolation between those bookmarks already supplied with the media stream. The progress bar can also be integrated with a set of chapter titles, such as for example in a feature movie or a sequence of television episodes in a television show season; such chapter titles might be treated as selectable “scenes” as described above. In the context of the invention, there is no particular requirement that the progress bar is linear: for example, a season of N episodes might be presented as one linear progress bar with N parts, or as N separate progress bars (possibly varying by their presentation length, or by some other parameter, and possibly joined end-to-end, or with explicit spacing in-between), or any other presentation appealing to the user. The controlling user at the touch panel can see at a glance when the progress of the presentation approaches a chapter (or episode or scene) ending, or a scene marked using metadata for the attention of that controlling user, and can also see how far forward or back must be skipped to return to a preferred bookmark.

For an example, not intended to be limiting in any way, the touch panel might show (a) a still picture associated with each bookmark or watchpoint, (b) a still picture or short loop associated with wherever the user selects on the progress bar, (c) a still picture associated with a selected offset, plus or minus, from wherever the user selects on the progress bar, and the like.

For an example, not intended to be limiting in any way, the touch panel might allow the user to (a) focus on a particular segment of an entire media stream, such as for example one defined as a 10-minute segment of a 120-minute movie, (b) focus on a particular set of features of an entire media stream, such as for example those scenes in a 120-minute movie in which Kate Beckinsale appears, either shown as a sequence of still pictures, short loops, or as a form of markup on the progress bar, (c) focus on a subsegment of an already-focused on segment, with the effect of focusing on shorter and shorter segments, or shorter segments with particular actors, or segments with selected multiple actors, and the like, (d) focus on other Boolean combinations thereof, such as for example AND and OR operations applied to the examples above, (e) and other focusing techniques such as hyperlinks, overlays, and the like.

For an example, not intended to be limiting in any way, the touch panel might show a frame including a presentation of a substantially similar graphic output as being made on the home entertainment screen, as described above, with metadata associated with the presentation (more precisely, with the media stream associated with that presentation) being optionally presented in other regions outside the frame, such as for example, to the left, right, bottom, or top of that frame, and the like.

For an example, not intended to be limiting in any way, the touch panel might show a frame including a presentation of a substantially similar graphic output as being made on the home entertainment screen, as described above, with metadata associated with the presentation (more precisely, with the media stream associated with that presentation) being optionally presented in the same region as the frame, such as for example as a subtitle, supertitle, balloon statement by a character, line pointing into the frame with commentary either inside or outside the frame, and the like.

For an example, not intended to be limiting in any way, the touch panel might show a frame including a presentation of a substantially similar graphic output as being made on the home entertainment screen, as described above, with metadata including a progress bar showing the amount of the media stream having so far been presented, yet to be presented, or both, or some other selection of the media stream, such as those focused-upon sections described above.

Although described as a “progress” bar herein, in the context of the invention, there is no particular requirement that the progress bar actually designates or is responsive to actual “progress” on the part of the system in presenting the media stream. For an example, not intended to be limiting in any way, in embodiments of the invention where the media stream instead represents a database or a set of other data, the “progress” bar might represent an index into that database or that set of other data, rather than (or in addition to) a measure of the amount of the data available in association with that title.

The progress bar might be augmented with significant additional metadata, such as one or more of the following.
A set of bookmarks or watchpoints associated with portions of the media stream, such as might be indicated by highlighting, line segment separators, or pointers to specific locations in the progress bar. For example a set of “chapters” in a movie might be pointed to and those pointers labeled, with the effect that the viewer could return to, or skip to, the beginning of a chapter with one touch on the touch panel.
A set of parental control or other metadata associated with portions of the media stream, such as might be indicated by highlighting, line segment separators, or pointers to specific locations in the progress bar. For example, a progress bar for the media stream might have portions colored or highlighted in red to indicate violence, yellow to indicate language, green to indicate sexually explicit material, and blue to indicate frightening scenes (or other colors, of course). Scenes with multiple such features might be striped or otherwise indicate those multiple features. This would have the effect that the viewer could skip over, or deliberately replay, those portions of the media stream.

In a second aspect, the invention is embodied in a system that includes features of the guide and mosaic user interfaces, as described in the incorporated disclosure. As described in the incorporated disclosure, the guide user interface allows the user to review metadata about each title, with the effect that the user might sort a list of thousands of possible titles with the effect of restricting the titles visible in the window to only a group of those that user is interested in, from which selection of the title the user wishes to view is presumably significantly easier. As described in the incorporated disclosure, the mosaic user interface allows the user to visually picture the relative “closeness” (according to some measure) of multiple titles, with the effect that the user might determine which titles are similar to those the user has liked, again from which selection of the title the user wishes to view is presumably significantly easier. In one embodiment the touch panel includes a presentation of individually selected titles by their cover art, with the associated metadata for those titles also presented on the touch panel. This has the effect that the user can view textual metadata for titles concurrently with viewing cover art (even possibly animated cover art) for those titles.

In a second embodiment, the touch panel might present its information in “mosaic” mode, in which the screen space available to the touch panel represents a substantial duplicate of what is presented on the main home entertainment screen, with the effect that the user does not lose focus on any visual action while using the touch panel.

For an example not intended to be limiting in any way, when the user touches the cover art for a particular title, action is taken depending on whether that title is the focused-upon title (which in one embodiment is shown using highlighting or other emphasis). For example, in one embodiment, the following actions might be taken.
If the title (or other object) is highlighted, that is, focused-upon, the system performs a default action for that title or other object.
   In the mosaic format, if the object is cover art for a media stream, touching that object shows a set of detailed information for that media stream.
   In the guide format, if the object is a row associated with a media stream, touching that row a set of detailed information for that media stream.
   In either the mosaic or the guide format, if the object is a row of a menu of control elements (such as for example the main menu or the parental control menu), the system performs the associated action for that menu item.
If the title (or other object) is not highlighted, that is, it is not focused-upon, the system highlights that object, and in some cases, centers that object.
   In the mosaic format, if the object is cover art for a media stream, touching that object centers and highlights it, and reshuffles the set of other cover art displayed with the mosaic.
   In the guide format, if the object is a row associated with a media stream, touching that centers and highlights that row.
   In the guide format, if the object is a column (of metadata associated with media streams), touching that column highlights and sorts that column.
   Touching a non-highlighted tab, in a “collections” screen of collections of media streams, highlights that tab and shows the media streams in that collection.
   Touching a non-highlighted row in a menu highlights that row.

The inventors have found that the described behavior is superior to known user interfaces. In some known user interfaces, touching (or “clicking on”) an object just causes that object to become highlighted, whether or not it was highlighted already, and a different action entirely (such as for example double-clicking or pressing a different button) to perform a default action for that object. These known techniques would not be as suitable for a touch panel interface, since at least (a) double-clicking is difficult to perform reliably by a user with a touch panel, (b) a relatively small touch panel display might not have sufficient room for another button to touch.

More generally, the user interface provided by the invention has the property that the user need only “press what's interesting.” If the “interesting” object is something newly-interesting, the system presents it as the focused-upon item. If the “interesting” object was already indicated as interesting, the system performs a default action for that “interesting” object. In alternative embodiments, the user might set parameters to alter the default action, either temporarily or until changed again.

In alternative embodiments, the touch panel might be used to present a relatively large collection of data in a natural way that the user might navigate.

For an example, not intended to be limiting in any way, when the user touches a selected location on the screen, the screen is redrawn in response to the selected location. This might or might not cause the screen to be rearranged for cover art associated with that location, but might (a) move the screen in an X or Y direction, (b) change the scale of the display, with the effect of “zooming in” or “zooming out”, with the effect of moving the screen in a Z direction, (c) perform a focusing operation as described above, thus effecting a selection much like querying a database.

More generally, if titles are related to each other by some measure of “closeness”, the system might respond to distinct actions by the user by redrawing the screen to reflect responses to distinct commands by that user. For example, a right sweep might indicate to start panning the screen dynamically to the right, and other gestures (left sweep, circle, squiggle, “graffiti”-like symbols, and the like) might indicate other commands by that user.

More generally, in the context of the invention, there is no particular requirement that the titles chosen for display on the screen must be static. For example, the system might periodically redraw at least some of those titles, in response to time. For an example, not intended to be limiting in any way, the system might redraw each title on the screen with a new one periodically (or with a probabilistic parameter such as a Poisson distribution), with the effect that the screen is redrawn nearly entirely after a period of about 5-10 minutes. For an example, the probabilistic parameter might be responsive to active or passive metadata about users in the region with the presentation element, with the effect that the screen is redrawn more slowly when there are few (or no) users present, and more quickly when there are more (or at least some) users present.

More generally, the invention might be used to navigate a 2D representation of any kind. In one embodiment, the 2D representation of titles gives the impression of navigating an infinite plane (R²), where duplicates of titles are presented to prevent the user from reaching an edge of that plane. In alternative embodiments, there need not be duplicates of any titles, and the user might reach an edge where the titles to be found are farthest away, by some measure of closeness, from the focused-upon title. In one embodiment, the user might use the touch panel to “walk” substantially randomly (either intentionally or by caprice) along the infinite plane. In the context of the invention, there is no particular requirement that the 2D surface to be presented is like a plane. For an example, not intended to be limiting in any way, in one embodiment, the 2D representation of titles gives the impression of navigating a finite torus with a finite number of holes, where duplicates of titles are presented as a natural result of circling the torus along one or more of its axes.

For an example, not intended to be limiting in any way, the cover art is typically arranged in a rectilinear pattern, with offsets for each row so that scrolling either horizontally or vertically will eventually show all available titles. In one embodiment, the cover art might be arranged in another pattern, such as a hexagonal pattern, or a rectilinear pattern with some overlap of cover art, so as to either space the cover art out more and allow easier selection of moving cover art, or to cluster the cover art together and allow the viewer to see more selections.

For an example, not intended to be limiting in any way, the system might be responsive to the user touching the touch panel in more than one location, either substantially simultaneously, with very brief delay, or within a delay associated with a time parameter. The user might touch (1) two or more separate titles, such as with two or more fingers, (2) a curved or straight line on which lie multiple titles, (3) “doubleclick” on a title by touching it twice, (4) “clicking and dragging” a title by touching it and drawing a line to another region of the touch panel, and the like. In one embodiment, the system will attempt to determine a preference the user is expressing, and to act upon it.

After reading this application, those skilled in the art would recognize that the invention provides an enabling technology by which substantial advance is made in the art of user interfaces and human-machine control systems.

For example, the invention might be used to provide one or more of, or some combination or extension or mixture of, any of the following.
In the context of the invention, there is no particular requirement that the elements to be displayed in the mosaic-like format involve cover art, titles, or presentable media streams. For an example, not intended to be limiting in any way, the mosaic-like format might show individual still pictures from the media stream (again arranged according to some measure of “closeness” to be determined). The mosaic-like format might show individual scenes or short play-loops from the media stream (again arranged according to some measure of “closeness” to be determined). The mosaic-like format might show actors or characters, whether alone or in combination, and whether in the abstract or included in titles having particular genres.
Similarly, in the context of the invention, there is no particular requirement that the elements to be displayed in the mosaic-like format involve media streams or presentable audio/video of any kind. For an example, not intended to be limiting in any way, the mosaic-like format might show individual still pictures of persons from a database (such as for example: a casting database of actors, a database of prospective investors, an employee database, and the like), again arranged according to some measure of “closeness” to be determined, that measure of “closeness” possibly having nothing to do with looks. The mosaic-like format might show individual titles or paragraphs from a database of research papers, again arranged according to some measure of “closeness” to be determined. The mosaic-like format might show programming errors and vulnerabilities, or known viruses or other malware for an application or operating system, again arranged according to some measure of “closeness” to be determined

After reading this application, these and other and further uses of the invention would be clear to those skilled in the art.

### BRIEF DESCRIPTION OF THE DRAWINGS

FIG. 1 (collectively including FIGS. 1A and 1B) shows a block diagram of a system including a touchpad user interface.

FIG. 2 shows a process flow diagram for a method of operating a system including a touchpad user interface.

### INCORPORATED DISCLOSURES

This application incorporates by reference and claims priority of at least the following documents.
U.S. Provisional Patent Application No. 60/488,367, filed Jul. 15, 2003, attorney docket number 217.1019.01, titled “Bookmarks and Watchpoints for Selection and Presentation of Media Streams”.
U.S. patent application Ser. No. 10/418,949, filed Apr. 18, 2003, attorney docket number 217.1017.01, titled “Grid-Like Guided User Interface for Video Selection and Display”.
U.S. patent application Ser. No. 10/418,739, filed Apr. 18, 2003, attorney docket number 217.1018.01, titled “Mosaic-Like User Interface for Video Selection and Display”.
U.S. patent application Ser. No. 10/655,496, filed Sep. 3, 2003, attorney docket number 217.1019.02, titled “Bookmarks and Watchpoints for Selection and Presentation of Media Streams”.

These documents are hereby incorporated by reference as if fully set forth herein, and are sometimes referred to herein as the “incorporated disclosure”. Inventions described herein can be used in combination or conjunction with technology described in the incorporated disclosure.

### DETAILED DESCRIPTION OF THE PREFERRED EMBODIMENT

In the description herein, a preferred embodiment of the invention is described, including preferred process steps and data structures. Those skilled in the art would realize, after perusal of this application, that embodiments of the invention might be implemented using a variety of other techniques not specifically described, without undue experimentation or further invention, and that such other techniques would be within the scope and spirit of the invention.

Definitions

The general meaning of each of these following terms is intended to be illustrative and in no way limiting.
The phrase “media stream”, and the like, describes information intended for presentation in a sequence, such as motion pictures including a sequence of frames or fields, or such as audio including a sequence of sounds. As used herein, the phrase “media stream” has a broader meaning than the standard meaning for “streaming media,” (of sound and pictures that are transmitted continuously using packets and that start to play before all of the content arrives). Rather, as described herein, there is no particular requirement that “media streams” must be delivered continuously. Also as described herein, media streams can refer to other information for presentation, such as for example animation or sound, as well as to still media, such as for example pictures or illustrations, and also to databases and other collections of information.
The phrase “digital content”, and the like, describes data in a digital format, intended to represent media streams or other information for presentation to an end viewer. “Digital content” is distinguished from packaging information, such as for example message header information. For the two phrases “digital content” and “media stream,” the former describes a selected encoding of the latter, while the latter describes a result of presenting any encoding thereof.
The phrase “digital media,” and the like, describes physical media capable of maintaining digital content in an accessible form. Digital media includes disk drives (including magnetic, optical, or magneto-optical disk drives), as well as any other physical media capable of maintaining information, such as digital content.
The term “bookmark”, and the like, describes a reference to a logical location selected within a media stream. In one embodiment, bookmarks are not necessarily preselected by the creator or distributor of that media stream, and are possibly dynamically selected by a recipient of digital content representing that media stream. In one embodiment, presentation devices are capable of starting or restarting presentation from a selected bookmark.
The terms “watchpoint”, and the like, describe a reference to a logical state of a presentation device, such as for example a logical location selected within a media stream. In one embodiment, watchpoints are capable of associating one or more events therewith, and (preferably) those one or more events might be conditioned on some other data or state information. For one example, the user might designate a bookmark at the beginning of a selected film clip, a watchpoint with the end of that same film clip, and an event associated with the watchpoint, which event directs a presentation device to return to a presentation state it was at before presenting from the bookmark. In this example, the film clip effectively acts as a media element capable of being inserted into another, different, media stream, without involving any other digital content associated with the larger media stream that contains that film clip.
The phrase “content server”, and the like, describes a device (or a portion thereof, or a set of such devices or portions thereof) capable of sending digital content to recipients. For example, a content server might include a web server at which a user is provided the capability of purchasing digital media for download. In the context of this application, there is no particular requirement that the server be (logically or physically) located at any particular address or place, or have any particular architecture, or use any particular protocol for communication. For example, the content server might include a process logically available to a local presentation device.
The phrase “media object”, and the like, refers to a file, or collection of files, maintained at a local or remote server or on an optical medium such as a DVD or on another digital medium, that holds digital content. In one embodiment, the file or collection of files is structured as it was on one side of a DVD or both sides of a DVD or other optical medium or other digital medium before being copied onto a local or remote server. In this embodiment, this has the effect that a single-sided DVD would usually be associated with a single media object, while a double-sided DVD would be associated with two (or possibly one) separate media objects. In one embodiment, the file or collection of files is structured as it was when downloaded from a remote content server. In one embodiment, each media object has an associated “media hash” value, computed in response to at least a portion of the digital content representing the media object. In one embodiment, each media hash value is maintained using a “content database” (at a remote server) and using a cached local content database.
The phrases “control rules”, “parental control rules”, “presentation control rules”, and the like, refer to rules imposed by a controller of the local system (e.g., the home viewing system), that might restrict the ability of users (e.g., viewers) to obtain access (whether access to media streams, their metadata, or other information). For an example, not intended to be limiting in any way, one type of control rule might include a password override to allow a viewer to see R-equivalent media streams.
The phrases “control effects”, “parental control effects”, “presentation control effects”, and the like, refer to rules imposed by an owner of content (e.g., a media stream or portion thereof), that take effect when one or more control rules is invoked, such as by refusing to present, editing, or otherwise acting upon otherwise accessible information. For an example, not intended to be limiting in any way, one type of control effect might include an alternative scene to present to those viewers not authorized to see R-equivalent media streams.
The phrases “control rating”, “parental control rating”, “presentation control rating”, and the like, refer to condensed descriptions of content, with the effect that a controller of the local system can broadly refer to information having such ratings. For an example not intended to be limiting in any way, one type of rating might be “R for graphic violence”, providing the controller of the local system with brief information to determine if content chunks with that rating are appropriate for children aged 5 or under.
The phrases “touch panel”, and the like, refer to a device capable of both providing relatively high quality graphic output and of receiving input signals from a pointing device with substantially direct physical contact with the touch panel display, such as a finger or stylus, with the effect that the user has the natural feeling of identifying or controlling screen elements that are presented.

The scope and spirit of the invention is not limited to any of these definitions, or to specific examples mentioned therein, but is intended to include the most general concepts embodied by these and other terms.

System Elements

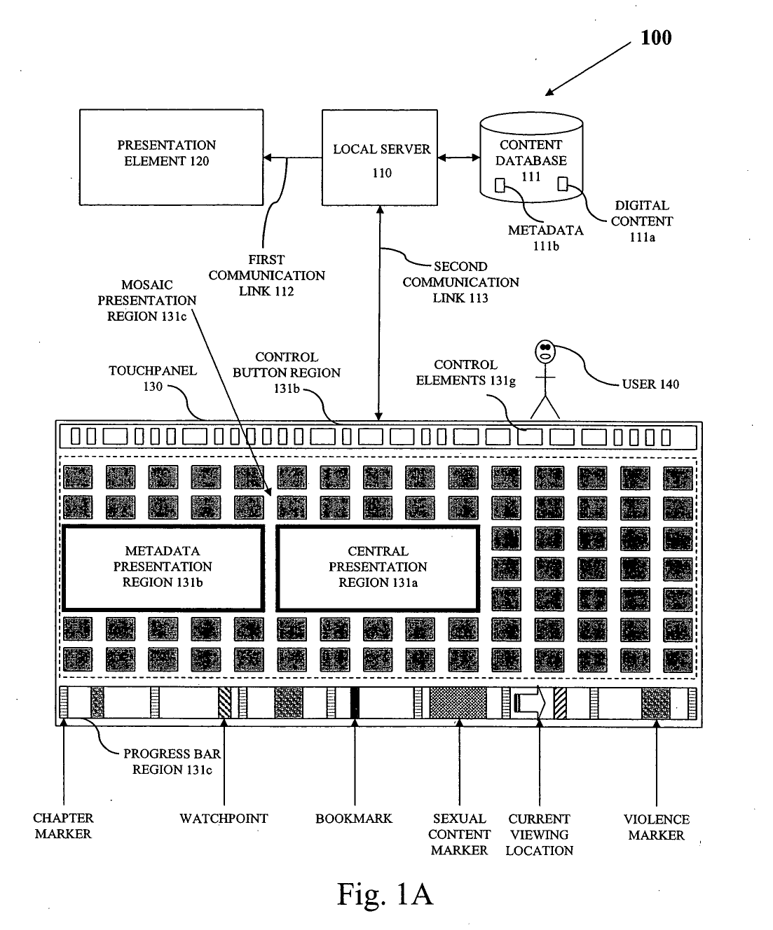

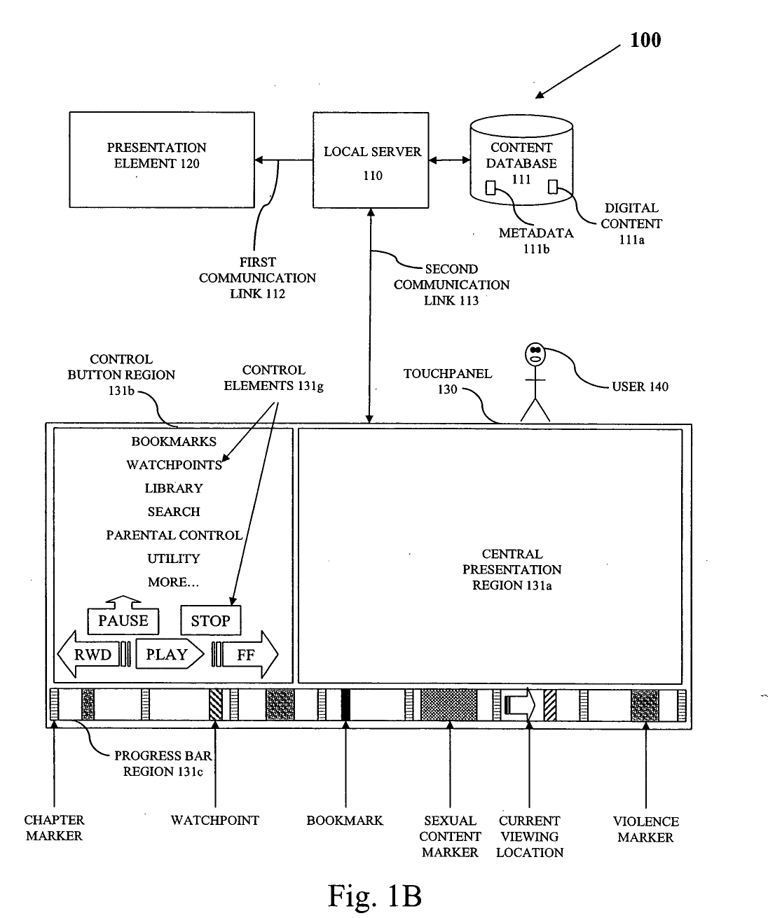

FIG. 1 (collectively including FIGS. 1A and 1B) shows a block diagram of a system including a touchpad user interface.

A system 100 includes elements as shown in FIG. 1, plus possibly other elements as described in the incorporated disclosure. These elements include at least a local server 110, a (home entertainment) presentation element 120, and a controlling touch panel 130 disposed for operation by a controlling user 140.

The local server 110 includes elements as shown in FIG. 1, plus possibly other elements as described in the incorporated disclosure. These elements include at least a content database 111, a first communication link 112 to the presentation element 120, a second communication link 113 to the touch panel 130, and at least some processing capability (such as for example, a processor, control and data memory, and mass storage). In one embodiment, the local server 110 is capable of using the first communication link 112 to communicate bidirectionally with the presentation element 120, and is capable of using the second communication link 113 to communicate bidirectionally with the touch panel 130.

In one embodiment, the content database 111 includes at least the following information. The content database ill includes elements as shown in FIG. 1, plus possibly other elements as described in the incorporated disclosure. These elements include at least the following information.
Digital content information 111a, associated with titles, describing media streams capable of presentation on the presentation element 120 and (at least in part) on the touch panel 130.
Metadata 111b, associated with those titles, describing further information about those media streams, useful to the user 140, such as for example, cover art, textual titles, brief descriptions of the titles, parental control ratings, brief descriptions of the genre associated with the title, the actors appearing in the title, the director and producer associated with the title, and the like. In one embodiment, metadata might be specified for the entire title, or preferably, might be specified for individual portions of the title, to a granularity capable of being comprehended by the user 140.

The touch panel 130 includes elements as shown in FIG. 1, plus possibly other elements as described in the incorporated disclosure. In one format, these elements include at least the following information.
A central presentation region 131a, including a focused-upon title. The central presentation region 131a allows the user 140 to distinguish the focused-upon title from other titles, and to decide if the user 140 wishes to present the focused-upon title.
A metadata presentation region 131b, including presentation of metadata regarding the focused-upon title. The metadata presentation region 131b allows the user to obtain further information about the focused-upon title, and is available with sub-regions for touching to give commands to the local server 110. For an example, not intended to be limiting in any way, these commands might include to present the focused-upon title, to move to another title with a same or similar set of actors, to rearrange the mosaic presentation region 131c, and the like.
A mosaic presentation region 131c, including presentation of cover art for other titles than the focused-upon title. The mosaic presentation region 131c allows the user to view other titles in response to their “closeness” to the focused-upon title, using some measure of “closeness”. In one embodiment, typically, the more distant a title is shown on the touch panel 130 (and on the presentation element 120), the less close it is to the focused-upon title.

Using this format, the user 140 might browse the selection of available titles, view cover art and (other) metadata for those titles, and select one or more of those titles for presentation. In one embodiment, presentation occurs on both the presentation element 120 and on the touch panel 130.

In one format, these elements include at least the following information.
A central presentation region 131d, including a presentation of the focused-upon title. The central presentation region 131d allows the user 140 to watch the media stream, either on the presentation element 120 or on the touch panel 130. In the event that the user 140 watches the media stream on the central presentation region 131d, the user 140 does not have to divert his or her attention when using any of the control elements 131g on the touch panel 130.
A control button region 131b, including a set of control elements 131g which the user 140 might use with presentation of the focused-upon title. The control elements 131g might include elements for changing channel and volume, as well as for other manipulation of the media stream, such as for example to set and use bookmarks and watchpoints, or to set parental controls, or to designate a version of the media stream to be presented (for example, in response to parental controls).
A progress-bar region 131c, including an enhanced progress bar regarding presentation of the focused-upon title. The progress-bar region 131c allows the user 140 to view how far along the media stream is in its presentation. For an example, not intended to be limiting in any way, the progress-bar region 131c might include a representation of the entire media stream, with associated indicators showing (a) where the most recent bookmark, watchpoint, chapter beginning, or scene beginning was, (b) where the next upcoming bookmark, watchpoint, chapter beginning, or scene beginning will be, (c) where selected scenes, such as selected “favorite” scenes, scenes selected using criteria noted above with regard to the summary of the invention, and the like, appear in the media stream, (d) where previews, credits, out-takes, and the like, associated with the primary feature appear in the media stream, and (e) what scenes are linked to related media streams, such as an ending of the media stream linking to a next episode, a scene in a media stream linking to a near-identical stream in another title such as the Woody Allen version of “Casablanca”, and the like. In one embodiment, the progress-bar region 131c is also labeled with metadata, including at least some of the following: bookmarks and watchpoints (which might be indicated by lines or arrows), parental control metadata (which might be indicated by color coding), and the like.

Using this format, the user 140 might view a presentation of one particular available title, while concurrently maintaining control over features of that presentation which the user 140 might desire to skip or repeat. For an example, not intended to be limiting in any way, the touchscreen 130 might provide control elements 131g with which the user might indicate the desire to skip or repeat the next one of, or a class of, scenes in the media stream. For an example, not intended to be limiting in any way, these control elements 131g might be dynamically generated, with the effect that (say) as the media stream nears content marked for parental control for violence, a control element 131g would appear on the screen asking if the user desires to skip that violent scene.

Method of Operation

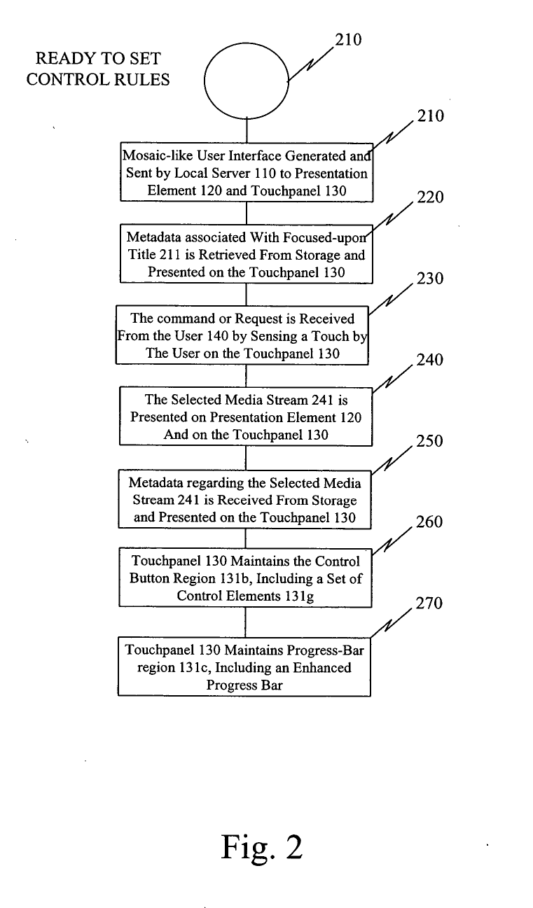

FIG. 2 shows a process flow diagram for a method of operating a system including a touchpad user interface.

Although described serially, the flow points and method steps of the method 200 can be performed by separate elements in conjunction or in parallel, whether asynchronously or synchronously, in a pipelined manner, or otherwise. In the context of the invention, there is no particular requirement that the method must be performed in the same order in which this description lists flow points or method steps, except where explicitly so stated.

The method 200 includes steps as shown in FIG. 2, plus possibly other steps as described in the incorporated disclosure. These elements include at least the following steps.
A step 210 of presenting a mosaic-like user interface on the presentation element 120 and on the touch panel 130, including a focused-upon title 211.
A step 220 of presenting a set of metadata regarding the focused-upon title 211.
A step 230 of receiving a command or request from the user 140, such as in the form of touching the touch panel 130 at a particular location 231.
A step 240 of presenting a selected media stream 241 on the presentation element 120 and on the touch panel 130.
A step 250 of presenting a set of metadata regarding the selected media stream 241 on the touch panel 130.
A step 260 of maintaining the control button region 131b, including a set of control elements 131g which the user 140 might use with presentation of the selected media stream 241.
A step 270 of maintaining the progress-bar region 131c, including an enhanced progress bar regarding presentation of the selected media stream 241.

At a step 210, the mosaic-like user interface is generated, and sent by the local server 110 to the presentation element 120 and on the touch panel 130. In one embodiment, the local server 110 might generate the mosaic-like user interface, while in alternative embodiments, the mosaic-like user interface may be generated relatively remotely and sent to the local server 110. The mosaic-like user interface includes at least one focused-upon title 211.

At a step 220, the metadata associated with the focused-upon title 211 is retrieved from storage (such as for example, a database), and presented on the touch panel 130. In one embodiment, the local server 110 might generate the mosaic-like user interface, while in alternative embodiments, the mosaic-like user interface may be generated relatively remotely and sent to the local server 110.

At a step 230, the command or request is received from the user 140 by sensing a touch by the user 140 on the touch panel 130. However, after reading this application, those skilled in the art would recognize that actual touching is not required. For an example, not intended to be limiting in any way, the touch panel 130 might include a proximity sensor for a stylus or other object, the touch panel 130 or other sensor might detect nearness of an element broadcasting in RF or other frequencies, the touch panel 130 or other sensor might include an IR or visible light sensor combined with a processing element for detecting when a “touch” should be noted, the touch panel 130 might be sensitive to noise (including possibly spoken commands from the user 140) or to chemical compounds on a stylus, and the like.

At a step 240, the selected media stream 241 (as selected by the user 140 at the step 230 with a “present media stream” or “present title” command) is presented on the presentation element 120 and on the touch panel 130. The local server 110 sends the same selected media stream 241 to both the presentation element 120 and the touch panel 130.

At a step 250, metadata regarding the selected media stream 241 is retrieved from storage (such as for example, a database), and presented on the touch panel 130. In one embodiment, the metadata might be similar to the metadata presented in the step 220.

At a step 260, the touch panel 130 maintains the control button region 131b, including a set of control elements 131g which the user 140 might use with presentation of the selected media stream 241. In one embodiment, the control elements 131g are maintained by the touch panel 130 using a processor and memory, while in alternative embodiments, the control elements 131g might be maintained relatively remotely and sent to the touch panel 130 for presentation to the user 140.

At a step 270, the touch panel 130 maintains the progress-bar region 131c, including an enhanced progress bar regarding presentation of the selected media stream 241. In one embodiment, the enhanced progress bar includes at least some of the following.
A progress bar showing, in substantially real-time, how far along in the media stream the presentation has been conducted.
A set of bookmarks or watchpoints showing, scaled relative to the size of the progress bar, when those bookmarks or watchpoints would be reached after uninterrupted presentation. In one embodiment, the bookmarks or watchpoints are indicated by thin vertical lines top-to-bottom along the height of the (relatively wider than higher) progress bar. In one embodiment, the bookmarks or watchpoints are indicated by pointers (such as arrows) to locations along the progress bar. For an example, not intended to be limiting in any way, a set of “chapters” in a movie might be pointed to and those pointers labeled, with the effect that the user 140 could return to, or skip to, the beginning of a chapter with one touch on the touch panel 130.
A set of color coding or gray-scale shading showing, relative to some arbitrary scale, a parental control rating associated with a portion of the media stream. For an example, in the event that the entire media stream is relatively innocuous, but includes one very graphic violent scene, that one scene might be marked (and a watchpoint/bookmark pair set) to indicate the scene, with the effect that the user 140 might skip that one scene if the viewing audience is inappropriate to that one scene. For an example, not intended to be limiting in any way, parental control or other metadata associated with portions of the media stream might be indicated by highlighting, line segment separators, or pointers to specific locations in the progress bar. The progress bar region 131c might have portions colored or highlighted in red to indicate violence, yellow to indicate language, green to indicate sexually explicit material, and blue to indicate frightening scenes. Scenes with multiple such features might be striped or otherwise indicate those multiple features.
   Alternative Embodiments

Although preferred embodiments are disclosed herein, many variations are possible which remain within the concept, scope, and spirit of the invention. These variations would become clear to those skilled in the art after perusal of this application.

After reading this application, those skilled in the art will recognize that these alternative embodiments and variations are illustrative and are intended to be in no way limiting. After reading this application, those skilled in the art would recognize that the techniques described herein provide an enabling technology, with the effect that heretofore advantageous features can be provided that heretofore were substantially infeasible.

### TECHNICAL APPENDIX

The set of inventive techniques are further described in the Technical Appendix. After reading this application and its Technical Appendix, those skilled in the art would recognize how to make and use the invention. All reasonable generalizations of techniques shown in this application and its Technical Appendix are within the scope and spirit of the invention, and would be workable, without further invention or undue experimentation.

At least the following documents are part of the technical appendix.
U.S. Provisional Patent Application No. 60/488,367, filed Jul. 15, 2003, attorney docket number 217.1019.01, titled “Bookmarks and Watchpoints for Selection and Presentation of Media Streams”.
U.S. patent application Ser. No. 10/418,949, filed Apr. 18, 2003, attorney docket number 217.1017.01, titled “Grid-Like Guided User Interface for Video Selection and Display”.
U.S. patent application Ser. No. 10/418,739, filed Apr. 18, 2003, attorney docket number 217.1018.01, titled “Mosaic-Like User Interface for Video Selection and Display”.
U.S. patent application Ser. No. 10/655,496, filed Sep. 3, 2003, attorney docket number 217.1019.02, titled “Bookmarks and Watchpoints for Selection and Presentation of Media Streams”.

The Technical Appendix is submitted with this application and hereby made a part of this application. The Technical Appendix, and all references cited therein, are hereby incorporated by reference as if fully set forth herein.

This Technical Appendix is intended to be explanatory and illustrative only, and not to limit the invention in any way, even if few (or only one) embodiment is shown.

1. A method, including steps of
presenting at least a portion of a media stream;
maintaining at least some metadata regarding that media stream; and
presenting a set of control elements, at least some of those control elements being dynamically responsive to a function of those steps and that metadata.

2. A method as in claim 1, wherein those steps of presenting are performed
in at least a portion of a presentation panel; and
concurrently with at least some of those control elements.

3. A method as in claim 1, wherein those steps of presenting include presenting at least a portion of a substantially identical media stream in a home entertainment system.

4. A method as in claim 1, wherein that metadata includes at least one of
a set of alternative media streams available for presentation;
a set of bookmarks or watchpoints regarding that media stream;
a set of parental control information regarding that media stream;
a status of those steps of presenting that media stream.

5. A method as in claim 4, wherein those alternative media streams include at least one of
alternative or enhanced versions of characters in the media stream;
alternative or enhanced versions of products in the media stream;
alternative or enhanced versions of scenes in the media stream.

6. A method as in claim 1, wherein that metadata includes an association with at least one other media stream.

7. A method as in claim 6, wherein that association includes a sequence of scenes from distinct media streams.

8. A method as in claim 1, wherein that property of being dynamically response includes at least one of: altering those control elements in response to that function.

9. A method as in claim 1, wherein that function is responsive to at least one of
a set of alternative media streams available for presentation;
a set of bookmarks or watchpoints regarding that media stream;
a set of parental control information regarding that media stream;
a status of those steps of presenting that media stream.

10. A method as in claim 9, wherein those alternative media streams include at least one of
alternative or enhanced versions of characters in the media stream;
alternative or enhanced versions of products in the media stream;
alternative or enhanced versions of scenes in the media stream.

11. A method as in claim 1, including steps of activating those control elements at least in part with at least one of
an element involving movement substantially near those control elements;
an element involving substantially direct physical contact;
an element involving a pointing device.

12. A method as in claim 11, wherein that element involving movement includes a sensor regarding movement of an object within a projected field visible to a user.

13. A method as in claim 11, wherein that element involving contact includes a touch panel.

14. A method as in claim 11, wherein that element involving a pointing device includes a light pen or mouse.

15. A method as in claim 1, wherein those control elements include a progress bar.

16. A method as in claim 15, wherein that progress bar includes information regarding at least one of
a state of a timed presentation;
a state of a location in a database.

17. A method as in claim 15, including steps of navigating at least one media stream in response to that progress bar.

18. A method as in claim 15, including steps of maintaining at least one association between that progress bar and at least one set of metadata.

19. A method as in claim 18, wherein that metadata includes at least one of
a set of alternative media streams available for presentation;
a set of bookmarks or watchpoints regarding that media stream;
a set of parental control information regarding that media stream;
a status of those steps of presenting that media stream.

20. A method as in claim 19, wherein those alternative media streams include at least one of
alternative or enhanced versions of characters in the media stream;
alternative or enhanced versions of products in the media stream;
alternative or enhanced versions of scenes in the media stream.

21. A method as in claim 18, wherein that metadata includes at least one of information
already supplied with the media stream;
supplied from a source different from the media stream;
generated dynamically in response to other metadata.

22. A method as in claim 18, wherein that progress bar includes a plurality of segments, each substantially associated with at least a distinct portion of the media stream.

23. A method as in claim 22, including steps of receiving requests from a user to focus on at least a portion of the media stream.

24. A method as in claim 23, wherein that focused-upon portion of the media includes at least one of
a particular segment of the media stream;
a particular set of segments of the media stream, that particular set of segments bearing at least one common property;
a particular sub-segment or set of sub-segments of a portion of the media stream already focused-upon;
a Boolean function of a set of sub-segments of a portion of the media stream already focused-upon.

25. A method as in claim 23, including presenting that focused-upon portion of the media stream as a sequence of (at least one) still picture, short presentation loop, or markup on the progress bar.

26. A method as in claim 18, wherein that progress bar includes at least one of
a bookmark or watchpoint;
a position designated by a user;
each such bookmark or watchpoint, or position designated by a user, being associated with at least one of
a still picture or relatively short presentation loop associated with that bookmark or watchpoint, or position designated by the use,
a still picture or relatively short presentation loop associated with a selected offset, plus or minus, from that bookmark or watchpoint, or position designated by the user.

27. A method as in claim 15, including presenting that progress bar with visible indicators of associated metadata.

28. A method as in claim 27, including steps of receiving requests from a user to navigate the media stream in response to those indicators.

29. A method, including steps of
obtaining at least some metadata regarding a set of data elements, those data elements having a possible representation on a touch panel;
determining a measure of closeness from a focused-upon data element; and
defining a mapping from that measure of closeness onto a field having fewer dimensions than that metadata.

30. A method as in claim 29, wherein those data elements are associated with media streams.

31. A method as in claim 29, including steps of altering, in response to received information, at least one of
a presented portion of that field;
a selection of which data element is focused-upon.

32. A method as in claim 31, wherein that received information is responsive to at least one user movement relative to that field.

33. A method as in claim 31, wherein that received information includes a touched location on that touch panel.

34. A method as in claim 2b2, wherein those steps of altering a selection of which data element is focused-upon include steps of focusing-upon a data element associated with that touched location.

35. A method as in claim 31, wherein those steps of altering a presented portion of that field include steps of reordering at least some of the data elements presented in that field.

36. A method as in claim 29, including steps of presenting symbols associated with those data elements in response to that measure of closeness for substantially each of those data elements.

37. A method as in claim 36, wherein at least some of those symbols are moving within that field.

38. A method as in claim 37, wherein that movement is in response to at least one of
a change in a selection of which data element is focused-upon;
a change in that mapping;
at least one user movement relative to that field.

39. A method as in claim 36, wherein those steps of presenting are responsive to at least some of that metadata.

40. A method as in claim 36, wherein those symbols include at least one animated element.

41. A method as in claim 36, wherein those symbols include at least one sequence of still pictures.

42. Apparatus including
memory or mass storage maintaining at least a portion of a media stream;
memory or mass storage maintaining at least some metadata regarding that media stream; and
a set of control elements, at least some of those control elements being dynamically responsive to a function of those steps and that metadata.

43. Apparatus as in claim 42, including a presentation panel, wherein that presentation panel shows at least a portion of concurrently with at least some of those control elements.

44. Apparatus as in claim 42, including a home entertainment system showing at least a portion of a substantially identical media stream as that presentation panel.

45. Apparatus as in claim 42, wherein that metadata includes at least one of
a set of alternative media streams available for presentation;
a set of bookmarks or watchpoints regarding that media stream;
a set of parental control information regarding that media stream;
a status of those steps of presenting that media stream.

46. Apparatus as in claim 45, wherein those alternative media streams include at least one of
alternative or enhanced versions of characters in the media stream;
alternative or enhanced versions of products in the media stream;
alternative or enhanced versions of scenes in the media stream.

47. Apparatus as in claim 42, wherein that metadata includes an association with at least one other media stream.

48. Apparatus as in claim 47, wherein that association includes a sequence of scenes from distinct media streams.

49. Apparatus as in claim 42, including a control element, those control elements being responsive to that control element, wherein that control element includes at least one of
an element involving movement substantially near those control elements;
an element involving substantially direct physical contact;
an element involving a pointing device.

50. Apparatus as in claim 49, wherein that element involving movement includes a sensor regarding movement of an object within a projected field visible to a user.

51. Apparatus as in claim 49, wherein that element involving contact includes a touch panel.

52. Apparatus as in claim 49, wherein that element involving a pointing device includes a light pen or mouse.

53. Apparatus as in claim 42, wherein those control elements include a progress bar.

54. Apparatus as in claim 53, wherein that progress bar includes information regarding at least one of
a state of a timed presentation;
a state of a location in a database.

55. Apparatus as in claim 53, including memory or mass storage maintaining at least one association between that progress bar and at least one set of metadata.

56. Apparatus as in claim 55, wherein that metadata includes at least one of
a set of alternative media streams available for presentation;
a set of bookmarks or watchpoints regarding that media stream;
a set of parental control information regarding that media stream;
a status of those steps of presenting that media stream.

57. Apparatus as in claim 56, wherein those alternative media streams include at least one of
alternative or enhanced versions of characters in the media stream;
alternative or enhanced versions of products in the media stream;
alternative or enhanced versions of scenes in the media stream.

58. Apparatus as in claim 55, wherein that metadata includes at least one of information
already supplied with the media stream;
supplied from a source different from the media stream;
generated dynamically in response to other metadata.

59. Apparatus as in claim 55, wherein that progress bar includes a plurality of segments, each substantially associated with at least a distinct portion of the media stream.

60. Apparatus as in claim 55, wherein that progress bar includes at least one of
a bookmark or watchpoint;
a position designated by a user;
each such bookmark or watchpoint, or position designated by a user, being associated with at least one of
a still picture or relatively short presentation loop associated with that bookmark or watchpoint, or position designated by the use,
a still picture or relatively short presentation loop associated with a selected offset, plus or minus, from that bookmark or watchpoint, or position designated by the user.

61. Apparatus as in claim 53, including wherein that progress bar includes visible indicators of associated metadata.

62. Apparatus including
memory or mass storage maintaining at least some metadata regarding a set of data elements, those data elements having a possible representation on a touch panel;
memory or mass storage maintaining a set of instructions interpretable by a computing device to determine a measure of closeness from a focused-upon data element; and
memory or mass storage maintaining a set of instructions interpretable by a computing device to define a mapping from that measure of closeness onto a field having fewer dimensions than that metadata.

63. Apparatus as in claim 62, wherein those data elements are associated with media streams.

64. A method as in claim 62, including memory or mass storage, including in response to received information, at least one of
a presented portion of that field;
a selection of which data element is focused-upon.

65. A method as in claim 64, including a sensor generating an indication of a touched location on that touch panel.

66. A method as in claim 65, including memory or mass storage, including in response to that indication, a revised presented portion of that field.

67. A method as in claim 64, including memory or mass storage, including in response to that indication, a revised focused-upon data element.

68. A method, including steps of
maintaining at least some metadata regarding a set of data capable of being mapped onto a sequence; and
presenting a set of control elements, at least some of those control elements being alterable in dynamic response to that metadata.

69. A method as in claim 68, wherein those control elements include a progress bar.

70. A method as in claim 69, wherein that progress bar includes information regarding at least one of
a state of a timed presentation;
a state of a location in a database.

71. A method as in claim 69, including steps of navigating at least one media stream in response to that progress bar.

72. A method as in claim 69, including steps of maintaining at least one association between that progress bar and at least one set of metadata.

73. A method as in claim 69, including steps of presenting that progress bar with visible indicators of associated metadata.

74. A method as in claim 73, including steps of receiving requests from a user to navigate the media stream in response to those indicators.

75. A method as in claim 68, including steps of activating those control elements at least in part with at least one of
an element involving movement substantially near those control elements;
an element involving substantially direct physical contact;
an element involving a pointing device.

76. A method as in claim 75, wherein that element involving movement includes a sensor regarding movement of an object within a projected field visible to a user.

77. A method as in claim 75, wherein that element involving contact includes a touch panel.

78. A method as in claim 75, wherein that element involving a pointing device includes a light pen or mouse.

79. Apparatus including
memory or mass storage maintaining at least some metadata regarding a set of data capable of being mapped onto a sequence; and
a set of control elements, at least some of those control elements being alterable in dynamic response to that metadata.

80. Apparatus as in claim 79, wherein those control elements include a progress bar.

81. Apparatus as in claim 80, wherein that progress bar includes information regarding at least one of
a state of a timed presentation;
a state of a location in a database.

82. Apparatus as in claim 80, wherein that progress bar is associated with visible indicators of associated metadata.

83. A method, including steps of
receiving a signal from a touch panel indicating a touched location associated with an object;
determining if that object is focused-upon;
performing an action associated with the object in response to a result of that step of determining.

84. A method as in claim 83, wherein those steps of performing include at least one of
in the event that the object is focused-upon, performing a default action for that object;
in the event that the object is not focused-upon, performing an action other than that default action for that object.

85. A method as in claim 84, wherein that default action includes at least one of
in the event that the object is associated with a media stream, showing detailed information for that media stream;
in the event that the object is associated with a control element, performing an action associated with that control element.

86. A method as in claim 83, wherein those steps of performing include at least one of
in the event that the object is focused-upon, performing a first action for that object;
in the even that the object is not focused-upon, performing an action for that object including steps of focusing-upon that object.

87. A method as in claim 86, wherein those steps of focusing-upon that object include at least one of: centering that object, highlighting that object.

88. A method as in claim 87, wherein those steps of focusing-upon that object include
centering that object;
rearranging other objects in response to those steps of centering that object.

89. A method as in claim 87, wherein those steps of focusing-upon that object include sorting objects by metadata represented by that object.

90. A method as in claim 86, wherein those steps of focusing-upon that object include reordering at least some of the objects presented on the touch panel.

91. A method as in claim 86, wherein, in the event that object is associated with a collection of media streams, those steps of focusing-upon that object include
highlighting a region associated with that collection;
showing objects associated with media streams associated with that collection.

92. A method as in claim 86, wherein, in the event that object is associated with a control element, those steps of focusing-upon that object include highlighting that control element.

93. Apparatus including
means for receiving a signal from a touch panel indicating a touched location associated with an object;
means for determining if that object is focused-upon;
means for performing an action associated with the object in response to a result of that step of determining.

94. Apparatus as in claim 93, wherein those means for performing include at least one of
in the event that the object is focused-upon, means for performing a default action for that object;
in the event that the object is not focused-upon, means for performing an action other than that default action for that object.

95. Apparatus as in claim 94, wherein that means for performing a default action includes at least one of
in the event that the object is associated with a media stream, means for showing detailed information for that media stream;
in the event that the object is associated with a control element, means for performing an action associated with that control element.

96. Apparatus as in claim 93, wherein those means for performing include at least one of
in the event that the object is focused-upon, means for performing a first action for that object;
in the even that the object is not focused-upon, means for performing an action for that object including steps of focusing-upon that object.

97. Apparatus as in claim 96, wherein those means for focusing-upon that object include at least one of: means for centering that object, means for highlighting that object.

98. Apparatus as in claim 97, wherein those means for focusing-upon that object include
means for centering that object;
means for rearranging other objects in response to those means for centering that object.

99. Apparatus as in claim 97, wherein those means for focusing-upon that object include means for sorting objects by metadata represented by that object.

100. Apparatus as in claim 96, wherein those means for focusing-upon that object include means for reordering at least some of the objects presented on the touch panel.

101. Apparatus as in claim 96, wherein, in the event that object is associated with a collection of media streams, those means for focusing-upon that object include
means for highlighting a region associated with that collection;
means for showing objects associated with media streams associated with that collection.

102. Apparatus as in claim 96, wherein, in the event that object is associated with a control element, those means for focusing-upon that object include means for highlighting that control element.
